(19) United States
(12) Patent Application Publication
(10) Pub. No.: US 2014/0032359 A1
(43) Pub. Date: Jan. 30, 2014

(54) SYSTEM AND METHOD FOR PROVIDING INTELLIGENT RECOMMENDATIONS

(71) Applicant: Infosys Limited, Bangalore (IN)

(72) Inventor: Vikas Dewangan, Pune (IN)

(73) Assignee: Infosys Limited, Bangalore (IN)

(21) Appl. No.: 13/954,935

(22) Filed: Jul. 30, 2013

(30) Foreign Application Priority Data
Jul. 30, 2012 (IN) 3124/CHE/2012

(51) Int. Cl. G06Q 30/06

(52) U.S. Cl. CPC G06Q 30/0631
USPC 705/26.7

(57) ABSTRACT

One or more computing devices may determine a category of interest to a user, receive an image, extract one or more features in the image, determine a recommendation in the category of interest based, at least in part, on the one or more extracted features, and communicate the recommendation to the user. The image can be received from a video camera, a webcam, a digital camera, a scanner, a remote computing device, a mobile device, and/or a storage drive. The recommendation in the category of interest may be determined, at least in part, by one or more user preferences, or by historic data. Additionally, the one or more features which are extracted from the image may be based on the category of interest, user preferences, and/or historic data. The features can include user physical characteristics, clothing, facial features, expression, environment, patterns, shapes, aesthetic characteristics, furniture, furnishings, layout, colors, and/or dimensions.

### RELATED APPLICATION DATA

This application claims priority to India Patent Application No. 3124/CHE/2012, filed Jul. 30, 2012, the disclosure of which is hereby incorporated by reference in its entirety.

### FIELD OF THE INVENTION

The disclosed embodiment generally relates to a system and method for providing intelligent recommendations to a user.

### BACKGROUND

Online shopping has become a major source of commercial activity. Many online retailers utilize product recommendation systems which are designed to present products to customers based on customer preferences or profiles. However, such systems are limited because they do not utilize the full range of information sources that are available to them to provide recommendations.

### SUMMARY

The disclosed embodiment relates to a recommendation system which utilizes visual data to provide an intelligent recommendation. More specifically, a method, apparatus, and computer readable medium are disclosed which provide recommendations to a user based on an analysis of a received image.

According to the disclosed embodiment, an exemplary computer-implemented method comprises determining a category of interest to a user, receiving an image, extracting one or more features in the image, determining a recommendation in the category of interest based, at least in part, on the one or more extracted features, and communicating the recommendation to the user. The image can be received from a video camera, a webcam, a digital camera, a scanner, a remote computing device, a mobile device, and/or a storage drive.

The recommendation in the category of interest may be determined, at least in part, by one or more user preferences, or by historic data. Additionally, the one or more features which are extracted from the image may be based on the category of interest, user preferences, and/or historic data. Features can include user appearance, user physical characteristics, user clothing, user facial features, user expression, user environment, patterns in the environment, environmental characteristics, shapes, aesthetic characteristics, furniture, furnishings, layout, colors, and/or dimensions.

### BRIEF DESCRIPTION OF THE DRAWINGS

FIG. 1 is a flowchart of an exemplary method for providing one or more recommendations to a user according to the disclosed embodiment.

FIG. 2 shows a plurality of different image sources that an image can be received from according to the disclosed embodiment.

FIG. 3 is a flowchart of an exemplary method for extracting features from an image according to the disclosed embodiment.

FIG. 4 is a flowchart of an exemplary method for determining a recommendation from the extracted features according to the disclosed embodiment.

FIG. 5 shows an exemplary computing environment useful for implementing apparatuses and computer readable media, and performing methods according to the disclosed embodiment.

### DETAILED DESCRIPTION

While methods, apparatuses, and computer-readable media are described herein by way of examples and embodiments, those skilled in the art recognize that methods, apparatuses, and computer-readable media for interacting with a computing device are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Methods, apparatuses and computer-readable media are disclosed which provide users with intelligent recommendations based, at least in part, on an analysis of one or more features extracted from an image.

Overview of Recommendation System

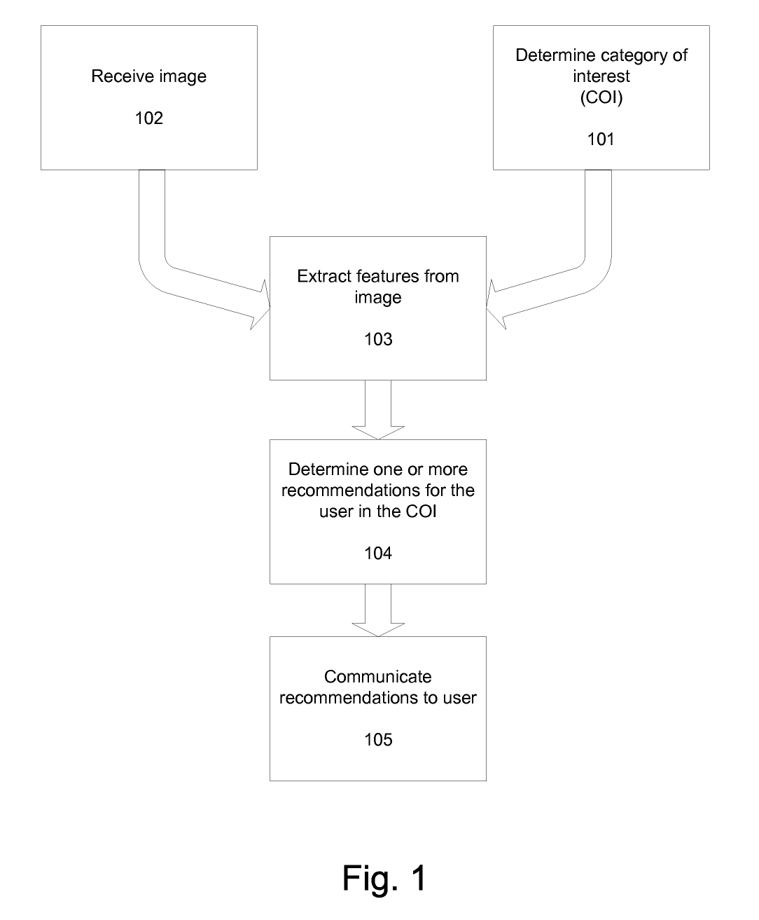

FIG. 1 illustrates an exemplary method according to the disclosed embodiment. In step 101 a category of interest (COI) is determined. The COI may be determined in a variety of different ways. For example, a user can be browsing an online product or services catalog and input or select a specific category that they are looking for products or services in. The COI can be a subcategory as a well as a category, such as for example running shoes, which are a specific type of athletic shoe. The category can also be determined automatically based on user actions or selections, such as when a user searches for a certain product or clicks on a particular advertisement. For example, the user can be browsing an e-commerce site and click on an ad for a particular table lamp. From this selection, the category of lighting appliances can be determined to be the COI. The COI can vary in scope and can be defined, for example, very broadly, such as a category corresponding to furniture, as well as very narrowly, such as a category corresponding to red Ming Dynasty vases. Additionally, user profile data or historical data, such as previous searches, can be used to determine a COI. Optionally, this step can be skipped and the recommendation system can provide recommendations in a broad array of categories that can be relevant to a particular image.

In step 102 an image is received. This image can be received prior to, after, or contemporaneously with the determination of the COI. For example, the image can be uploaded from the user computing device after a COI is determined in response to a prompt by the system asking for an image. Alternatively, the image can be provided by the user to be stored as part of a user profile and retrieved when the user is online shopping. In one example, the image is automatically captured by the user computing device using a device such as a webcam and received by the recommendation system after determination of a COI. There are many possible ways of receiving an image at the recommendation system, and the methods disclosed herein are not intended to be limiting.

The image is analyzed at step 103 in order to extract relevant features. The determination of which features are extracted is discussed in greater depth below, but the features can include any component of the image which can be used to aid the recommendation system in providing a recommendation to the user. So in the earlier example where the COI is running shoes, the system may prompt the user to place their foot in front of the webcam, or to otherwise transmit a picture of their foot to the system. Features such as the length of their foot, their foot arch, and other measures can be extracted from the image. The features do not have to be related to the user's person specifically, and can be any part of an image. In another example, a user may be looking for a nightstand to match their other bedroom furniture. In that case, the user can upload a picture of their bedroom and the features extracted can be the colors, textures, dimensions, and/or shapes of the pieces of furniture in their bedroom.

The extracted features can be used to determine one or more recommendations for the user in the COI in step 104. There are many ways this can be accomplished, and they are discussed in greater detail below. The extracted features can be used to derive characteristics or traits about a user, and those characteristics or traits can then be used to find a product which is designed for a user with those characteristics or traits. In the running shoe example, an analysis of the user's foot arch may result in a determination that the user has a very low arch and therefore will benefit from shoes which provide additional support to absorb the impact that runners with low arches feel in their feet when they run. The features can also be used to derive characteristics or traits of objects in the image. In the example of the nightstand, an analysis of the bedroom furniture features in the image can result in a determination that the user has primarily dark oak furniture and result in a recommendation of nightstands which will match the user's theme.

After one or more recommendations are determined, they are communicated to the user in step 105. The recommendations can be communicated via an electronic message, such as an email, SMS, or other electronic document. The recommendations can be automatically delivered to the user's home as part of a promotion or other offer. The recommendations can also be communicated to the user via a phone call or voice mail. Additionally, the recommendations can be displayed on the user's computing or mobile device as part of an e-commerce website, product or services catalog, toolbar, or browser plug-in.

Image Sources

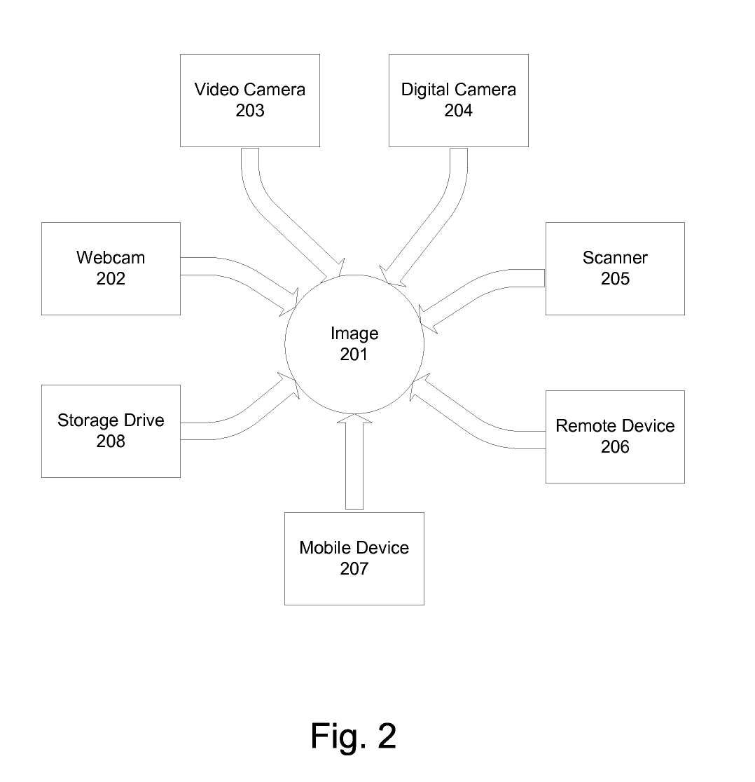

FIG. 2 shows a variety of different image sources that can be used to provide the image to the recommendation system. The image can be captured by a webcam 202 or a video camera 203, in which case it can be a frame or multiple frames of a video file. Additionally, the image can be captured by a digital camera 204 and transferred to a computing device that is communicatively coupled to the recommendation system. The image can be a picture that the user has taken with an old photo film camera and scans in via a scanner 205. Of course, the image does not have to be a picture that the user has taken or even necessarily a picture of the user or their surroundings. One example is a situation where a user sees a photograph in a magazine of a living room set that they like and wants to purchase something similar. In that situation, the user can scan or otherwise transmit the picture from the magazine to the recommendation system for use in producing a furniture recommendation for the user that will be similar to the featured living room set.

The image can be received from a remote source 206, such as a friend's computer, an online server where the user stores their files, or some third party website where the user spots an image they want to use. In the example where the image is on a third party website, the user can simply enter the URL of the image into a user interface associated with the recommendation system, and the image can then be retrieved. Another possible image source is the user's mobile device 207. The user can wirelessly transmit an image from their mobile device over a wireless or cellular data network to the recommendation system. Additionally, the picture or image can be stored on and transmitted from a storage drive 208, such as a USB thumb drive.

Extraction of Features

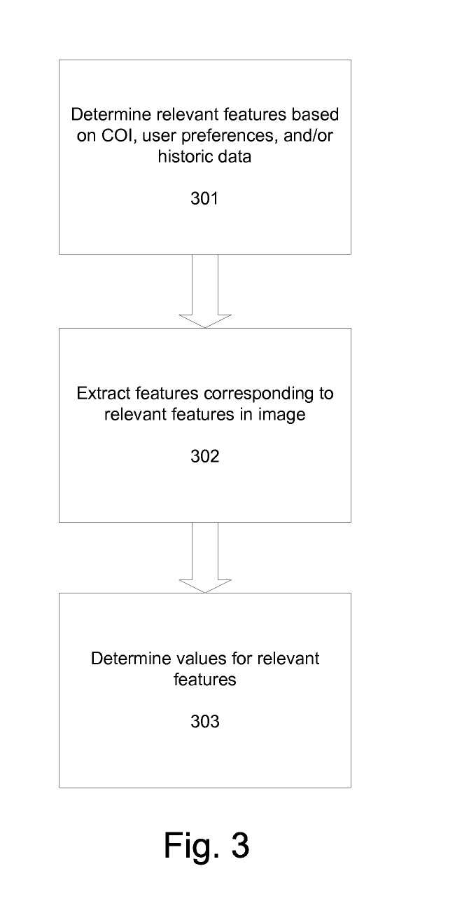

FIG. 3 illustrates an exemplary method of extracting features from the image according to the disclosed embodiment. At step 301 relevant features can be determined based on the COI, user preferences, and/or historic data. For example, if the user is searching for beauty products and the image that is received includes the user in front of their computer, then the recommendation system can determine that the features relating to the user and not their environment are relevant, based on the COI of beauty products. These features can include skin tone, eye color, eye shape, jaw, lip size, hair type, hair color, facial shape, facial hair, etc. If the user is searching for t-shirts, then the features extracted from an image can be shoulder width, neck size, length of torso, etc. In another example, the COI can be dining room furniture, in which case the identified relevant features can be the shape of a room, dimensions, wallpaper, paint color, and/or other furniture or accent items. These features are not intended to be limiting, and the recommendation system can utilize any and all features such as user appearance, user physical characteristics, user clothing, user facial features, user expression, user environment, patterns in the environment, environmental characteristics, shapes, aesthetic characteristics, furniture, furnishings, layout, colors, or dimensions. If the COI step is skipped, then multiple sets of relevant features may be determined to provide recommendations in multiple categories.

User preferences can be utilized to determine relevant features in addition to, or in place of, COI. One example of utilizing user preferences is a situation where a user is shopping for furniture but has indicated that they are primarily concerned with spatial requirements rather than aesthetic concerns. In such an example, the dimensions of a room and the available space in a room can be identified as the relevant features while the aesthetic features relating to the existing furniture the room can be ignored.

Historic data may also be utilized to determine relevant features. In the example where the user is searching for beauty products, the recommendation system may determine that there is a strong historical correlation between a customer's skin tone and the color of lipstick they prefer, but no correlation between a customer's lip size and the color of lipstick they prefer. Based on this, the user's skin tone may be identified as a relevant feature while lip size is ignored. Another scenario is where the user has shown a historical bias towards a certain set of features over another. In one example of this, the user can be searching for a new pair of sneakers, and the recommendation system can recognize that the most important indicator in the user's past sneaker purchasing decisions has been the color of the shoes in comparison to the color of the clothes of the user in the received image. In that case, the color of the user's clothes may be determined to be the single most important relevant feature for determining a recommendation for the user.

After the relevant features are determined, the features corresponding to the relevant features are extracted from the image at step 302. This may be accomplished by any suitable recognition or detection algorithm. For example, in the situation where the relevant feature is a facial feature, a facial detection algorithm may be employed to determine where in the image the face, or faces, are located. After that, further recognition algorithms may be used to identify sub-features such as eyes, hair, chin, skin tone, etc. In many cases, an intelligent or self-learning algorithm may be employed to detect objects. In such a situation, the recognition process can be the result of an analysis of different possible objects that can correspond to an object in the image. For example, the system may have access to a database of common objects or furniture, such as couches, loveseats, tables, ottomans, and other items and may determine the strength of the match between an object in the image and an item in the database. If the object is not matched to an item in the database, an image search can be performed on the web to see if a match is found, and the match can automatically be added to the database. The features extracted may correspond to a particular relevant feature but at the same time be a different actual feature. For example, if the relevant feature is the gender or age of a user, a number of different facial and physical features can be extracted to help make that determination. For gender, the features can be presence of facial hair, facial shape, jawline, forehead, and other gender specific features. For age, the features can be presence of wrinkles, hairline, baldness, posture, whiteness of hair, and other age-related features.

At step 303, the extracted features are used to determine values for the relevant features in order to later determine a recommendation for the user. This may include setting one or more variables representing the relevant features to the values of the features in the image. For example, if an identified relevant feature is couch color and an image contains a red couch, the couch may be extracted in step 302, and a variable representing the color of the couch may be set to “red” in step 303. The relevant features may be represented as one of a plurality of different possible settings. For example, one of the relevant features may be hair color, which may have a number of discrete possible values. In some situations, the value of the relevant feature may be an estimation based on a plurality of different features, such as when the relevant feature is age.

Determination of Recommendations

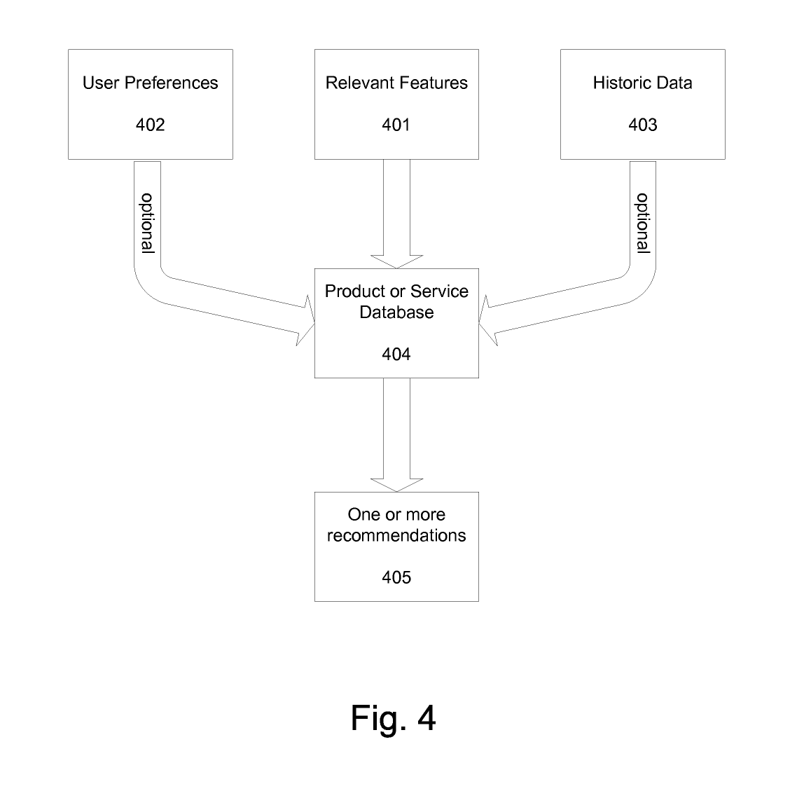

FIG. 4 illustrates an exemplary method for determining one or more recommendations for the user according to the disclosed embodiment. The relevant features 401 previously determined are used with a product or service database 404 in order to provide one or more recommendations to the user 405. The database is shown for illustration only, and the product or service information can be stored in any tangible computer readable medium, including distributed servers, P2P networks, and the like. The recommendations may be retrieved from the database based on a single relevant feature or a combination of relevant features. For example, if the user is searching for a shampoo, then the user's hair type may be the determinant for retrieving a recommended item. In another example, the COI may be hair dyes, in which case the relevant features can be gender, hair type, and current hair color.

Different algorithms or techniques can be used for retrieving recommendations from the product or service database. User preference information 402 can be utilized along with the relevant features 401 in determining a recommendation. In the example where the user is looking for furniture, they can indicate, via a user interface, that they are most concerned that the material and color of the new furniture matches the existing furniture. These preferences can then be used to accord more weight to the relevant features pertaining to material and color than to other relevant features such as style or shape. So if the user's existing furniture is all beige leather, then the new furniture recommendations may be beige leather as well. Preference information can be retrieved from a user's preexisting profile and utilized in conjunction with relevant features as well. For example, where the user is searching for running shoes and the image contains a picture of their foot, the relevant feature of the user's foot arch structure may be used in conjunction with information from their profile indicating that their favorite color is red to provide product recommendations of red shoes which will fit their foot.

Another factor that can influence the recommendation provided to a user can be historic data 403. Prior data regarding preferences of consumers and transaction or click through patterns can be used to determine or filter a list of products or services that are most likely to be well received by a user. In one example, a user may be looking for a good hair salon to get a haircut. Online reviews or other information sources accessible to the recommendation system may indicate that a particular hair salon has good reviews from customers who fit the user's demographic profile and hair type, and may utilize this information to recommend that hair salon over other similar hair salons. In an example where the user is searching for a product, the recommendation system may track the activity of prior users to determine which recommendations are most frequently clicked on or purchased by certain types of users or by users looking for certain items, and use that information to weigh the recommendations that are provided to the current user. There are many different ways that historic information can be used in conjunction with the recommendation system, and the variations disclosed herein are not intended to be limiting.

Presentation and Filtering of Recommendations

The recommendations may be communicated to the user in a variety of ways. The recommendations can be communicated via an electronic message, such as an email, SMS, or other electronic document. The recommendations can be automatically delivered to the user's home as part of a promotion or other offer. The recommendations can also be communicated to the user via a phone call or voice mail. Additionally, the recommendations can be displayed on the user's computing or mobile device as part of an e-commerce website, product or services catalog, toolbar, or browser plug-in.

When the recommendations are displayed to the user, they may be filtered, sorted, or ranked by various criteria. These criteria can include relevance, popularity, and/or price. The user can also filter the recommendations by sub-categories within the COI. For example, if the user is searching for clothing, they can filter recommendations by the kind of fit, or the fabric.

Computing Environment

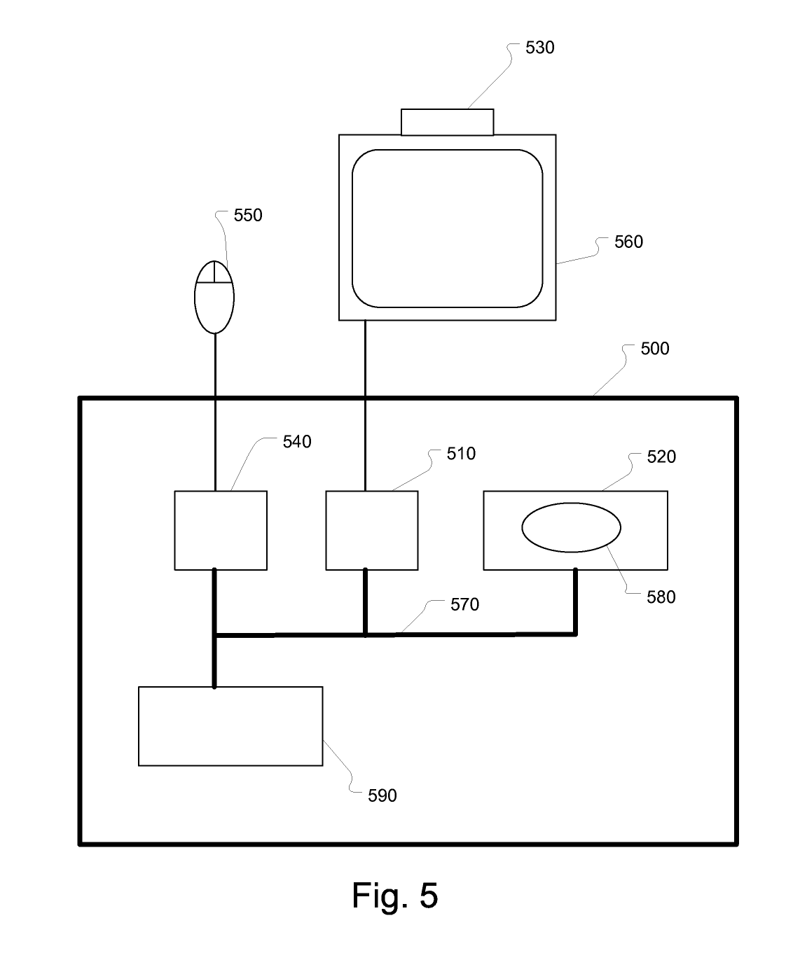

One or more of the above-described techniques can be implemented in or involve one or more computer systems. FIG. 5 illustrates a generalized example of a computing environment 500. The computing environment 500 is not intended to suggest any limitation as to scope of use or functionality of described embodiments.

With reference to FIG. 5, the computing environment 500 includes at least one processing unit 510 and memory 520. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM), non-volatile memory (e.g., ROM, EEPROM, flash memory, etc.), or some combination of the two. In some embodiments, the memory 520 stores software 580 implementing described techniques.

A computing environment may have additional features. For example, the computing environment 500 includes storage 540, one or more input devices 550, one or more output devices 560, and one or more communication connections 590. An interconnection mechanism 570, such as a bus, controller, or network interconnects the components of the computing environment 500. Typically, operating system software (not shown) provides an operating environment for other software executing in the computing environment 500, and coordinates activities of the components of the computing environment 500.

The storage 540 may be removable or non-removable, and includes magnetic disks, magnetic tapes or cassettes, CD-ROMs, CD-RWs, DVDs, or any other medium which can be used to store information and which can be accessed within the computing environment 500. In some embodiments, the storage 540 stores instructions for the software 580.

The input device(s) 550 may be a touch input device such as a keyboard, mouse, pen, trackball, touch screen, or game controller, a voice input device, a scanning device, a digital camera, or another device that provides input to the computing environment 500. The output device(s) 560 may be a display, printer, speaker, or another device that provides output from the computing environment 500.

An optional image capture device 530 may be a camera, video camera or any other similar device which can be used to capture images or video. The camera or video camera can be based on any known technologies including thermal, infra-red, acoustic or other camera technologies.

The communication connection(s) 590 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 500, computer-readable media include memory 520, storage 540, communication media, and combinations of any of the above.

Of course, FIG. 5 illustrates computing environment 500, display device 560, image capture device 530, and input device 550 as separate devices for ease of identification only. Computing environment 500, display device 560, image capture device 530, and input device 550 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 500 may be one or more servers, for example a farm of networked servers, a clustered server environment, or a cloud network of computing devices.

Having described and illustrated the principles of our invention with reference to described embodiments, it will be recognized that the described embodiments can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A computer-implemented method executed by one or more computing devices for providing a recommendation to a user, comprising:
determining, by at least one of the one or more computing devices, a category of interest to a user;
receiving, by at least one of the one or more computing devices, an image;
extracting, by at least one of the one or more computing devices, one or more features in the image;
determining, by at least one of the one or more computing devices, a recommendation in the category of interest based, at least in part, on the one or more extracted features; and
communicating, by at least one of the one or more computing devices, the recommendation to the user.

2. The computer-implemented method of claim 1, wherein the recommendation in the category of interest is determined, at least in part, by one or more user preferences.

3. The computer-implemented method of claim 1, wherein the recommendation in the category of interest is determined, at least in part, by historic data.

4. The computer-implemented method of claim 1, wherein the one or more features are extracted from the image based on at least one of the category of interest, user preferences, or historic data.

5. The computer-implemented method of claim 1, wherein the image is received from at least one of a video camera, a webcam, a digital camera, a scanner, a remote computing device, a mobile device, or a storage drive.

6. The computer-implemented method of claim 1, wherein the one or more extracted features comprise at least one of user appearance, user physical characteristics, user clothing, user facial features, user expression, user environment, patterns in the environment, environmental characteristics, shapes, aesthetic characteristics, furniture, furnishings, layout, colors, or dimensions.

7. An apparatus for interacting with one or more computing devices, the apparatus comprising:
one or more processors; and
one or more memories operatively coupled to at least one of the one or more processors and having instructions stored thereon that, when executed by at least one of the one or more processors, cause at least one of the one or more processors to:
determine a category of interest to a user;
receive an image;
extract one or more features in the image;
determine a recommendation in the category of interest based, at least in part, on the one or more extracted features; and
communicate the recommendation to the user.

8. The apparatus of claim 7, wherein the recommendation in the category of interest is determined, at least in part, by one or more user preferences.

9. The apparatus of claim 7, wherein the recommendation in the category of interest is determined, at least in part, by historic data.

10. The apparatus of claim 7, wherein the one or more features are extracted from the image based on at least one of the category of interest, user preferences, or historic data.

11. The apparatus of claim 7, wherein the image is received from at least one of a video camera, a webcam, a digital camera, a scanner, a remote computing device, a mobile device, or a storage drive.

12. The apparatus of claim 7, wherein the one or more extracted features comprise at least one of user appearance, user physical characteristics, user clothing, user facial features, user expression, user environment, patterns in the environment, environmental characteristics, shapes, aesthetic characteristics, furniture, furnishings, layout, colors, or dimensions.

13. At least one non-transitory computer-readable medium storing computer-readable instructions that, when executed by one or more computing devices, cause at least one of the one or more computing devices to:
determine a category of interest to a user;
receive an image;
extract one or more features in the image;
determine a recommendation in the category of interest based, at least in part, on the one or more extracted features; and
communicate the recommendation to the user.

14. The at least one non-transitory computer-readable medium of claim 13, wherein the recommendation in the category of interest is determined, at least in part, by one or more user preferences.

15. The at least one non-transitory computer-readable medium of claim 13, wherein the recommendation in the category of interest is determined, at least in part, by historic data.

16. The at least one non-transitory computer-readable medium of claim 13, wherein the one or more features are extracted from the image based on at least one of the category of interest, user preferences, or historic data.

17. The at least one non-transitory computer-readable medium of claim 13, wherein the image is received from at least one of a video camera, a webcam, a digital camera, a scanner, a remote computing device, a mobile device, or a storage drive.

18. The at least one non-transitory computer-readable medium of claim 13, wherein the one or more extracted features comprise at least one of user appearance, user physical characteristics, user clothing, user facial features, user expression, user environment, patterns in the environment, environmental characteristics, shapes, aesthetic characteristics, furniture, furnishings, layout, colors, or dimensions.
